(19) United States
(12) Patent Application Publication
(10) Pub. No.: US 2024/0311644 A1
(43) Pub. Date: Sep. 19, 2024

(54) ARBITRARILY LOW-LATENCY INTERFERENCE WITH COMPUTATIONALLY INTENSIVE MACHING LEARNING VIA PRE-FETCHING

(71) Applicant: Avrio Analytics LLC, Knoxville, TN (US)

(72) Inventors: Michael Bertolli, Knoxville, TN (US); Alicia Caputo, Knoxville, TN (US)

(73) Assignee: Avrio Analytics LLC, Knoxville, TN (US)

(21) Appl. No.: 18/602,908

(22) Filed: Mar. 12, 2024

Related U.S. Application Data
(60) Provisional application No. 63/489,835, filed on Mar. 13, 2023.

(51) Int. Cl. G06N 3/096

(52) U.S. Cl. CPC G06N 3/096

(57) ABSTRACT

Methods for providing a machine learning (ML) final inference to a user, wherein an ML model and a computer-based content generation system (CGS) receives possible inputs and generates possible inferences, which are stored in association with the possible inputs to a memory so that they may be recalled based on the possible inputs. After receiving an actual input and an acceptability criterion, the CGS identifies a possible input that acceptably matches the actual input by satisfying the acceptability criterion. If a match is identified, the CGS substitutes the matching possible input in place of the actual input and outputs the possible inference corresponding to the matching possible input as the final inference to a user or to a second ML model. When a match is identified, inference is never performed on the actual input and the possible inferences are generated prior to receipt of the actual input.

### CROSS-REFERENCE TO RELATED APPLICATIONS

This application claims the benefit of U.S. Provisional Application No. 63/489,835 filed Mar. 13, 2023, and entitled ARBITRARILY LOW-LATENCY INFERENCE WITH COMPUTATIONALLY INTENSIVE MACHINE LEARNING VIA PRE-FETCHING, which is incorporated herein by reference in its entirety.

### FIELD

This invention relates generally to machine learning (ML), artificial intelligence, remote computer, and extended reality (XR). More particularly, the present invention relates to a method for providing a final inference using a bifurcated process based on pre-fetched partial or possible ML inferences.

### BACKGROUND OF THE INVENTION

For many systems, whether natural or artificial, there is at least some amount of delay between the receipt of information by that system and/or a request sent to that system and the formulation of an appropriate response to the information or request received. This delay may be termed the “System Achievable Response Time” (SART) and may be defined as the minimum amount of time that a system requires to process and respond to the receipt of an input (e.g., information, request, etc.). Meanwhile, a “system-required response time” (SRRT) is the maximum latency or the maximum amount of time that a system is allowed or is permitted to obtain a result. Thus, an issue arises if the minimum amount of time that a system requires to process and respond to the receipt of an input (i.e., the SART) is greater than the maximum amount of time that the system is allowed or is permitted to obtain such a result (i.e., the SRRT).

Systems in the field of machine learning and, more particularly, in the field of machine learning predictions and/or inferences (or “responses” from the machine-learning model), also have a SART that can dramatically impact the effectiveness and performance of those systems. The response time for such systems varies across domains and applications. For example, the SART for a system to recommend the best ad placement may differ dramatically when compared to the SART for the system to execute the purchase or sale of an asset upon a pricing change or to provide a response to verbal or written queries.

One area of machine learning where SART is particularly important is in the realm of applying machine learning to generating natural and realistic interactions (inferences). In such cases, the machine learning inferences might include, e.g., generating an appropriate conversational response (e.g., in a chatbot) or an operational instruction to a self-driving vehicle. A response might be any needed result, whether an actual response to a query or statement (e.g., such as in a natural language conversation), or a reaction to a change in context (e.g., predicting an action for a machine learning agent in a changing environment).

In many interactions, humans expect a response to their questions, statements, etc., within a certain expected or natural time frame (“Natural Response Time” or “NRT”), which may be described as the maximum amount of time that is acceptable for receiving a response to a given input. In certain cases, including the example given below, safety concerns determine what is and is not an acceptable NRT. In other cases, the NRT for a given input is determined based on how fast a human would respond to that same input. In those cases, whether a response to a given input is provided within the NRT or not is often one key factor that is used by humans in detecting and confirming that the interaction they are having is realistic and is not artificial.

Realistic interactions between two humans in providing these kinds of responses typically occur on different time scales that can vary based on physical, physiological, neurological, psychological, or other similar “internal” factors as well as “external” factors such as societal or cultural norms as well as situational contexts. For example, a human's reaction to visual stimuli is estimated to have a lower limit on the order of 180-200 milliseconds (ms), while the time required for a human to respond in a conversation will be dictated by (and indicative of) both the medium used for the conversation (e.g., in-person, phone, text) and the context. When a conversation partner's responses are slower (i.e., require more time) than the NRT, the perception that that response is provided by a human conversation partner will decrease. Therefore, for machine learning systems to produce more human-like (i.e., realistic) responses to inputs, such as during an interaction between a user and a chat bot, the SART for those interactions is preferably less than the NRT for a similar interaction. In certain preferred cases, the SART for those interactions mirrors the NRT for a similar interaction.

Unfortunately, when interacting with humans, modern machine learning models frequently cannot produce meaningful inferences or predictions (i.e., appropriate responses to inputs) within the SRRT or NRT because the machine learning result latency (i.e., delay) is often too high. In other words, the responses generated by many modern machine learning models are too slow and the lag in response time is either too slow for the system entirely or, even if fast enough for the system, is slow enough to be detectable by humans. Either case reduces the overall realism of the interaction. For this reason, the systems involved and/or the requirements placed on those systems are frequently altered to accommodate this system latency, which is often considered to be a hard (i.e., unalterable) limit or constraint placed on the interaction. For example, in the case of natural language conversations, chat bots are often configured to use text-based interactions instead of auto-generated speech (e.g., speech-to-text) interactions. While there are several reasons for this limitation, the use of auto-generated speech is often avoided because text-based interactions allow for a higher response latency (i.e., a higher NRT) without creating a bad (e.g., unrealistic, or not humanlike) user experience. That is, it is more acceptable for a user to wait 5-10 seconds for a text response (especially where visual indicators of “typing” or “processing” are presented) than to wait a similar time in a verbal conversation (even if including filler phrases such as “umm”), where the NRT is lower.

However, there are other use cases where the NRT must be critically prioritized. For example, in the case of a high-speed position correction system, where responses of the system have a NRT that is dictated by the ability of the model to maintain a particular position and velocity of or with respect to an object of interest (e.g., a rocket), failure to meet the NRT (i.e., taking too long to respond) is not simply “less than ideal” but could lead to catastrophic system failures (e.g., the rocket strikes an unintended target).

Another critical example is in the case of generating realistic human-computer interactions, such as might be done for training scenarios or entertainment. For example, a de-escalation training scenario might introduce a virtual avatar that takes the place of a traditional role-player. In that case, the human trainee is expected to interact verbally (and perhaps non-verbally, e.g., through body language) with the virtual avatar. A machine learning model may accept these interactions from the human trainee as input (possibly along with other input), and provide as a response, including possibly verbal and non-verbal reactions, which is played out by the avatar. However, the timing of that response can critically change the training scenario itself and, thus, influence the interactions with the trainee. For example, a trainee police officer may ask for the avatar to show their hands. A compliant human in a real-world scenario may respond within 1-2 seconds or less by showing their hands. Thus, 1-2 seconds is the NRT for this particular scenario. However, if latency in the machine learning response causes the avatar to show their hands after 5-6 seconds, rather than the less than expected 2 seconds that is typical of a compliant human responder, such a timescale can be interpreted as an indication of intentional hesitation or even danger by the officer, even when the training scenario is attempting to showcase a compliant virtual avatar. Thus, in that case, the latency has altered the training and may even cause the wrong behaviors to be learned, including the introduction of unwanted “training scars” (i.e., undesirable habits formed because of the training and its implementation, such as only ever showing a “shoot” scenario in “shoot/no shoot” training).

Several approaches attempt to lower the SART to meet the SRRT, or to allow the SART to match the NRT more closely. Technologies such as 5G with Edge Compute do so by moving the execution of the model inference to cloud servers that can decrease communication latency (i.e., lower-latency networking on 5G and a physically closer server), while also providing robust computing power (e.g., computer power that is greater than that possible on a local device, especially mobile devices). Another approach is applying more compute power (i.e., brute-force reduction of latency). However, even if such extreme computer power is available, it still cannot always achieve the desired performance. Another approach is to optimize the machine learning model, but this is rarely possible since initial models are typically already optimized. Another response is the simplification of the model (i.e., using a reduced form of the model that runs faster, or can be run locally on device such as a mobile device).

A final response is to simply accept longer reaction times. In certain cases, delay can be baked into the reaction medium. For example, a chat bot responding in text form can have a longer reaction time than a user may find acceptable verbally, especially where indications of “processing” can be provided (e.g., “Agent is typing . . . ”). In many cases, accepting longer reaction times is acceptable because the current use-cases are not time sensitive on timescales shorter than the inference. For example, there is little incentive for Apple Inc.'s Siri® voice assistant to return a result faster than what is currently possible, because those types of verbal interfaces with a smartphone are typically not considered time sensitive. Similar to how users accepted long load times for websites in the early internet, we have come to accept (for current use-cases) the reaction time of machine learning algorithms.

While rapid-response algorithms have been developed in other domains, they typically apply to very different use-cases and make use of well-structured responses (and often more structured data). For example, the inference of classifying an image has a well-structured response, where results are confined to a very limited and pre-determined space. However, for many high-quality and highly complex models (e.g., especially in the realm of natural language processing or “NLP”), the current approaches are insufficient to meet the NRT or even the SRRT. In many cases, the SART is greater than both the SRRT and the NRRT. This is especially true for use-cases like the de-escalation training example discussed above, where response times are inherent to the use-case itself (i.e., the response time plays a role in the scenario and its outcome). This means that the use-case, rather than system requirements, define the maximum allowable latency to match user expectation and/or training needs.

In the example of de-escalation and obtaining a natural language response, a response that arrives after a long delay can materially alter the training itself. That is, the delay in response is an inherent part of the training content because of the use-case. For example, a delay in response that results in the virtual avatar delaying in responding to a request (e.g., putting their hands up, dropping a weapon, etc.) can be the difference between a shoot situation and a no-shoot situation (alternatively, it could introduce that training scar of delayed officer reactions in the field). Next, while model simplification is frequently employed to lower the machine learning response latency (i.e., the SART) to meet the SRRT and NRT, such efforts can provide the worst results. While such efforts might achieve the desired reduction in latency, they can result in a decreased quality of the model response. For example, in the example above, simplifying the model might result in an avatar responding by speaking gibberish to the officer or ignoring key input.

Therefore, what is needed is a method for reducing model response latency (SART) to meet system-required response times (SRRT) more closely and/or natural response times (NRT) regardless of model complexity and, preferably, without any change to model complexity.

### SUMMARY OF THE INVENTION

The following presents a simplified summary of one or more implementations of the invention to provide a basic understanding of such implementations. This summary is not an extensive overview of all contemplated implementations and is intended to neither identify key or critical elements of all implementations, nor delineate the scope of any or all implementations. Its sole purpose is to present some concepts of one or more implementations in a simplified form as a prelude to the more detailed description that is presented later.

In some aspects, the techniques described herein relate to a method for providing a machine learning (ML) final inference to a user. The method includes providing a source of possible inputs for a ML model and providing a computer-based content generation system (CGS) that is configured to receive possible inputs from the source of possible inputs. The CGS includes a trained ML model that is configured to provide possible inferences that are each based on one of said possible inputs and a memory. With the CGS, the set of said possible inputs is received from the source of inputs and storing the set of possible inputs to the memory. A set of said possible inferences is generated using the ML model, wherein each possible inference in the set of possible inferences is based on a possible input of the set of possible inputs. The set of possible inferences is stored to the memory in a manner that associates each possible inference with the possible input upon which it is based such that the possible inference may be recalled by the CGS based on the associated one possible input. The CGS receives an actual input and an acceptability criterion and then compares the set of possible inputs stored to the memory with the actual input to identify a matching possible input within the set of possible inputs that acceptably matches the actual input by satisfying the acceptability criterion. If a matching possible input is identified in the set of possible inputs stored to the memory, the CGS is used to substitute the matching possible input in place of the actual input by recalling and then outputting the possible inference that is associated with the matching possible input as said final inference to the user in response to receiving the actual input. The possible inference and final inference are each preferably output to a memory and stored, such as a memory associated with a business logic system or other computer system for use or possible use by that system or by a user of that system. For example, in certain cases, eventually, the inference may be output to a connected device (e.g., a PC, mobile device, headset, etc.). In certain cases, the inference may be output directly, including possibly without being stored to a memory first. The particular device that receives the inference will vary depending on the application for which it is used.

In providing the final inference to the user where a matching possible input is identified, inference is never performed on the actual input. Additionally, the set of said possible inferences is generated prior to receipt of the actual input and not in real time with the receipt of the actual input.

In some aspects, the techniques described herein relate to a method for providing a machine learning (ML) final inference to a use. The method includes providing a source of possible inputs for a ML model and a computer-based content generation system (CGS) that is configured to receive possible inputs from the source of possible inputs. The CGS includes a trained first ML model that is configured to provide first possible inferences that are each partial inferences based on one of said possible inputs, a trained second ML model that is configured to provide second possible inferences that are each partial inferences based on one of the first possible inferences, and a memory. With the CGS, a set of said possible inputs from said source of inputs is received and stored to the memory. A set of said first possible inferences is generated using the first ML model, wherein each first possible inference is based on a possible input of the set of possible inputs. The set of possible inferences is stored to the memory in a manner that associates each possible inference with the possible input upon which it is based such that the possible inference may be recalled by the CGS based on the associated possible input. The CGS receives an actual input and an acceptability criterion and then compares the set of possible inputs stored to the memory with the actual input to identify a matching possible input within the set of possible inputs that acceptably matches the actual input by satisfying the acceptability criterion. If a matching possible input is identified in the set of possible inputs stored to the memory, the CGS is used to substitute the matching possible input in place of the actual input by recalling and then providing the first possible inference that is associated with the matching possible input as an input to the second ML model. Next, the second possible inference is generated using the second ML model based on the first possible inference that is associated with the matching possible input and that is provided as said input to the second ML model. Finally, the second possible inference is output to the user as said final inference. In providing the final inference to the user, where a matching possible input is identified, inference is never performed on the actual input. Additionally, the set of said first possible inferences is generated prior to receipt of the actual input and not in real time with the receipt of the actual input.

### NOTES ON CONSTRUCTION

Further advantages of the invention are apparent by reference to the detailed description when considered in conjunction with the figures, which are not to scale so as to more clearly show the details, wherein like reference numerals represent like elements throughout the several views, and wherein:

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred implementation thereof, and not to place a limitation on the scope of the invention. Nothing in the specification should be construed as indicating any element as essential to the practice of the invention unless so stated with specificity.

Unless noted otherwise, as the term is used herein, “system-required response time” or “SRRT” means a maximum latency that is permitted or that is enforced by a system in obtaining a given result. For example, website might impose a maximum time to respond to a transmission control protocol or “TCP” request before timing out (and possibly producing an error). These requirements are a part of the system design and may or may not have been user's expected time for response. Next, unless noted otherwise, as the term is used herein, “natural response time” means the latency allowed to obtain a result within a time frame that matches the expected user experience. For example, when speaking to someone else, people generally expect a response within several seconds in order to match the cadence of normal conversation. In that same conversation, a latency of several minutes would not “feel” like a natural conversation. Lastly, unless noted otherwise, as the term is used herein, “system achievable response time” or “SART” means the minimum amount of time that a system requires to process and respond to the receipt of an input (e.g., information, request, etc.).

As used herein, the term “inference” means the process of, once data is provided to a machine learning algorithm (or “ML model”), using the ML model to calculate an output, such as a single numerical score.

As used here, the term “content” means an output of an ML model, including but not limited to, classifications, numerical outputs (e.g., regressives), and generated content (e.g., audio, text, visual content).

The content that is output using the methods described can be used in a wide range out applications and can be output to “users” via devices, including but not limited to mobile devices, XR headsets, other computer systems, etc. These are sometimes referred to as “connected devices.” The content that is output is not limited to any particular type of application or device.

### BRIEF DESCRIPTION OF DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a diagrammatic representation of a method for providing a machine learning (ML) final inference to a user according to a first embodiment of the present invention;

FIG. 2 is a diagrammatic representation of a method for providing a machine learning (ML) final inference to a user according to a second embodiment of the present invention;

FIG. 3 depicts a video game controller for providing an input to control a computer-generated character avatar in a video game;

FIG. 4 depicts a computer-generated avatar that may be controlled using the controller shown in FIG. 3;

FIG. 5 depicts a computer-generated vehicle that may be controlled using the controller shown in FIG. 3; and

FIG. 6 is a representation of a substitution input according to an embodiment of the present invention.

### DETAILED DESCRIPTION OF THE INVENTION

One solution to the machine learning model response issue is the concept of pre-fetching, which can be thought of as pre-solving a portion of some (or all) of the potential problems that the system may be asked to solve to pre-generate partial potential answers to those problems. Those pre-generated, partial, or complete potential answers are then stored and used later to generate a complete answer or in response as a complete answer to an actual problem.

This may occur by, first, using a computer to generate some (or all) potential inputs to a given problem that may be received from a user, query, etc., based on some known state of possibilities or initial conditions. The known state of possibilities or initial conditions may come from any and multiple sources, including external conditions and constraints that may bear on the known state of possibilities. These may depend on the type of problem to be solved. For example, in a pricing algorithm for selecting an ideal, maximum, or minimum price of a good, an external constraint might be that the price can never go negative or that prices may not be raised or lowered by more than a certain amount or percentage.

Preferably, in using the methods disclosed herein, all possible inputs are provided, computed or are pre-fetched. Thus, in preferred implementations, the scope of valid and acceptable possible inputs is limited to a fixed or ascertainable number, even if a very large number. However, this method is not necessarily limited to those instances where the acceptable possible inputs are limited to a fixed or ascertainable number. If only some inputs are pre-fetched, preferably the “most likely” possible inputs are pre-generated, as determined by some selected methodology or based on certain acceptability criteria. To this end, in certain cases, the ML model includes or works cooperatively with an “accessory” ML model (e.g., an input generation model) that is used to predict and/or generate these possible inputs. In certain cases, this prediction process is trivial. However, in other cases, this prediction process is a field of modeling on its own. This constraint serves as a limit on the nature and type of problems that are suited for this method. Because of this constraint, use of this method is somewhat limited to those use cases where the prior generation (i.e., pre-fetching) of possible inputs can be achieved with sufficient coverage and accuracy.

With these generated inputs, the machine learning model can then pre-generate inferences for each of the inputs. These inputs can be stored in a fashion that relates them to the appropriate inputs, and may also include further categorization, such as type of input, semantic or other similarities to inputs, relationship among inputs (e.g., inputs that are numerically or hierarchically related), etc. Such categorizations and segmenting of inputs can also reduce the total number of possible inputs that need to be pre-computed. For example, if a particular machine learning model will produce the same inference (or sufficiently the same for a given use case) for a given class of inputs, then only one input and associated inference for that class need to be pre-generated. For example, an input of the word “cup” is likely, in most cases, sufficiently like the word “glass” that the same output would be appropriate in response to the use of either word. Then, when the model receives actual input from a user, it can return the pre-generated output associated with that input instead of running inference on the actual input, provided there is sufficient correlation (e.g., similarity) between the actual input and the anticipated or possible input. In this case and in this description, a “user” may be a human actor, a computer system or computer-based, non-human actor.

In cases where the actual input received is not identical to the possible inputs considered by the ML model, the categorization of inputs can assist in finding the pre-generated input that most closely matches the actual input, and then return the associated inference. In certain cases, statistical, hierarchical, semantic, or other analysis may be necessary to determine which pre-generated input is most closely matched. In other cases, matching an actual input to a possible input for which a response has been pre-generated, may be as simple as using a basic look-up of the nearest inputs according to a defined metric (e.g., a synonym of a word or numerical proximity). In such cases, one may place thresholds, including manually determined thresholds or thresholds determined by another means (e.g., another algorithm), on how “close” the pre-generated input must match. Thresholds may also be used to break ties (i.e., when the actual input matches more than one pre-generated input). In the description below, these constraints are called “acceptability criteria.”

In other cases, where no pre-generated input is found to match sufficiently to the actual input, inference can be performed “on-the-fly.” Performing inference in this manner is likely not favored in many cases due to the potential loss of time, temporary spike in latency, etc. In other cases, an error or other pre-determined result may be returned to the user when an acceptable match between the actual and possible inputs is not identified. Preferably, all interactions and especially failed interactions, such as those described above where no suitable match is provided, are used to further refine the input generation model, including its use as data for training input-generation machine learning algorithms.

The methods described above can be termed “pre-fetching,” where the computer system has already performed inference and has returned pre-generated results based on one or more inputs. In many cases, it is substantially faster to perform several inferences at once (i.e., simultaneously) than it is to perform the same number of inferences one after another in a sequence. This is particularly true when utilizing vectorized computational operations, where similar operations are applied in parallel to entire arrays instead of to individual elements one-by-one. Performing multiple operations in parallel does not incur the full cost of on-the-fly inferences, which would only delay the problem to later interactions rather than solving it.

Unless noted otherwise, including by context, as the term is used herein, “pre-fetching” means, given some or, preferably, all possible inputs that may be received in carrying out the method, generating an inference for each of those known possible inputs. Pre-fetching provides flexibility that enables the final inference, which is provided later on in response to receiving an actual input, to be tailored based on the actual input provided to the ML model. Dividing the inference process in this manner enables a portion of the computational work to be carried out and saved for later use at one point in time and then for the final inference process to be carried out very quickly, at a different point in time, by using the pre-fetched possible inferences. Preferably, the second half of this process occurs much quicker and more efficiently after receiving an actual input than performing inference using the same actual input but without utilizing the pre-fetched possible inferences.

In some cases, this concept of pre-fetching can also be a type of “partial fetching,”, where the possible inputs that are generated for pre-fetching may be used to generate partial inferences. These partial inferences are inferences that return the relevant feature at a particular level in the hierarchy, or the relevant semantic or latent representation, rather than the full inference. In such cases, the model may be run inference only on the first few layers and then store that output as latent information. These partial inferences can be stored in a fashion that relates them to the appropriate pre-generated inputs. It should be noted that, since partial inferences are generated, rather than complete inferences, it may be likely to find duplicate outputs. For this reason, the total number of possible outputs may be reduced (i.e., by removing duplicates), which can, advantageously, reduce the total amount of resources required in determining outputs for a given set of possible inputs.

Many machine learning algorithms, especially deep learning algorithms, develop latent variables or other representations that allow for the retention of important information in the input data. The concept of storing this knowledge has application to transfer learning and other fields but is also applicable to pre-fetching. For example, a deep convolutional neural network for classifying pictures of faces may learn semantic representations or a feature hierarchy on the images it receives as input data across its various layers. The early layers may encode information related to, for example, edges, with later layers encoding information of specific facial features. This is important, because it means that, while removing the final layers may result in poor classification for the initial use-case of the algorithm, it does not lose information of features derived in prior layers. Feature hierarchies and semantic or latent representations are present in other machine learning algorithms as well, including genetic algorithms.

Thus, one might achieve transfer learning by removing the final layers of a neural network (e.g., a face classification network, i.e., Problem #1) and adding different layers for a similar task (e.g., another image classification task, i.e., Problem #2). As an example, a first ML model might comprise a face classification network where the final layer is removed, and a second model might be essentially the same network but where a final layer is added to recognize various types of glassware. In that case, certain transferred knowledge from the first model, including recognizing edges and geometry, would be relevant and useful to second model regardless of the final problem solved. In certain cases, the layers that are removed might relate to certain follow-on tasks that can be replaced with other tasks. For example, after a face has been recognized using a face recognition model, a follow-on task might be to further identify facial expressions. The final layers related to recognizing facial expressions may be removed and replaced with other layers that carry out different follow-on tasks.

This procedure is commonly used as a means to speed the training of a classification model. In such cases, the first several layers, which may even be most layers, and which are applicable to both Problem #1 and Problem #2, are already trained and, therefore, their variables and parameters can be frozen. From there, only the new final layer(s), which are relevant only to Problem #2 are trained on a training dataset relevant to that new problem. This approach is powerful because, depending on how much of an existing network is re-used, the new task that it informs need only be minorly related. For example, transfer learning across disparate domains of image classification can be successful, relying only on hierarchical features such as edges and the commonality of taking images as input. This is true in other domains and types of machine learning models as well and is not limited to image classification models.

Next, in some cases, an actual input from a user cannot be identically or sufficiently matched to a pre-generated input. In such cases, the actual input may be matched to a broad classification of inputs. In other cases, the actual input may not be matched at all. To address this problem, the partial inference from an appropriate pre-generated input may be used as a pre-computed input to a potentially smaller machine learning model that performs the final stages of inference “on the fly.” This much smaller model can then achieve similar performance (e.g., accuracy) as the full model, but at much lower computational cost and, thus, at a lower latency by using the hierarchical or semantic or latent information as input. In such cases, the hierarchical or semantic or latent information is used as a pre-processed input. For example, the model used might include the first several layers of a neural network, which returns a derived, intermediary data feature containing semantic or latent information that is pre-computed from the pre-generated inputs and that is then returned through a type of lookup. That returned intermediary data feature may be passed to a smaller model that includes only, for example, a single-layer neural network and, therefore, executes very quickly, preferably within an acceptable latency for meeting the system-required timescale.

In effect, partial fetching joins the concept of pre-fetching with the approach of simplifying the model (i.e., using a reduced form of the model that runs faster or with fewer computational resources, such as is seen in transfer learning). Put differently, by pre-fetching a portion of the solution of a portion of a problem at one point in time, that partial solution can be used later to more quickly solve the entire problem. As noted above, simplifying the model can result in unacceptable model performance for certain use cases. However, it has been found that, combining model simplification with pre-fetching, returns results equivalent to those returned by a full, complex model while also balancing the need for pre-generating large amounts of input data.

The pre-fetching and partial fetching methods described above are particularly useful for, but are not limited to, training of personnel (e.g., de-escalation training for first responders). In such cases, the range of potential statements made by or to first responders in their role as first responders, including verbal and non-verbal statements or responses, is far more limited than the range of potential statements or responses made in everyday conversation. Therefore, it is possible to pre-generate all or most possible inputs that are expected to be received by a first responder during those interactions. Thus, in a hypothetical virtual training scenario featuring a virtual avatar, it is possible to pre-fetch reactions for the avatar to those possible inputs. The possible inputs that are pre-generated could be selected or even predicted by a model or other methodology that preferably considers the sequence of prior interactions (e.g., a portion or all the conversation up to that point) along with the context of the scenario. This could then provide a highly realistic, fully automated interaction with the avatar, where large and complex NLP models (e.g., GPT-3) could be used to generate appropriate responses. While those models take a long time to perform inference (e.g., several seconds to several minutes), pre-fetching could allow for very realistic response latency, not just realistic content. This is critical for use-cases like officer training, where response latency is as meaningful of a training parameter as the response itself. These same benefits would also be realized using the pre-fetching methods described earlier.

These same methods may be useful in creating and providing content in other computationally-heavy, such as in video games. While language processing models might use these methods to determine a best or appropriate phrase to output, these methods can also be used to generate other types of content. For example, creating realistic AI movement in video games is a computationally-heavy task because, among other things, the choice of action by the AI (e.g., seek cover, attack the player) with respect to the position, actions and attitudes of users/avatars must be considered along with a calculation of the interaction with the surroundings (e.g., different terrains, available navigation paths, presence of other AI, etc.). However, at the same time, a higher frame rate or refresh rate (i.e., the number of times that a screen is redrawn every second) is often considered a computationally-heavy task as well. For this reason, users are often asked to prioritize either frame rate or gameplay (in this case AI, or immersiveness). The methods described would permit certain determinations (e.g., AI characteristics, decision value, etc.) to be pre-determined based on a possible input (e.g., position) from a user. In such case, the response to those inputs can be determined and stored, which will free up resources for other tasks.

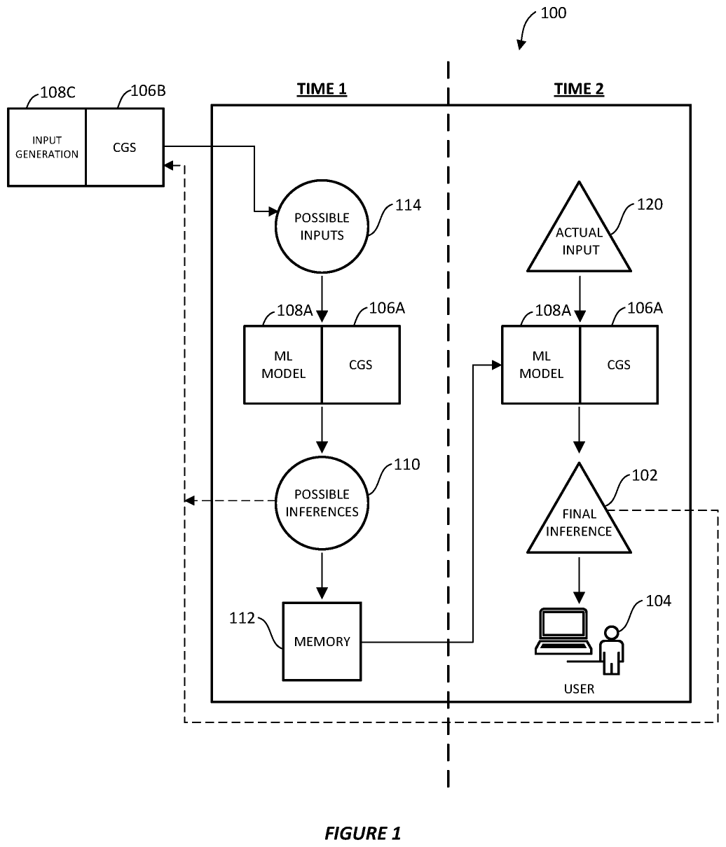

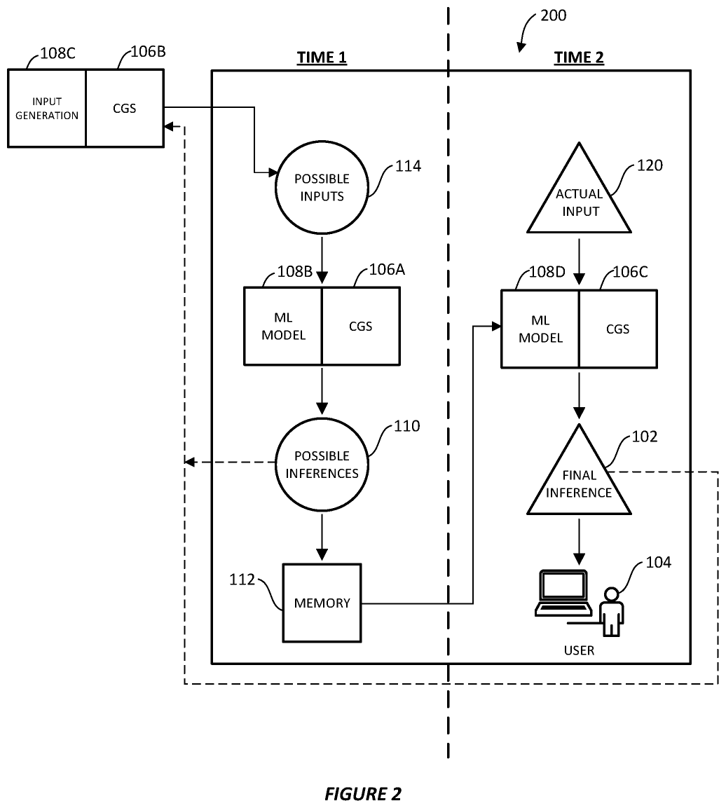

Now, non-limiting examples of the inventive concepts described above are described in the following discussion and are illustrated in the accompanying figures. Thus, referring now to the drawings in which like reference characters designate like or corresponding characters throughout the several views, there is shown in FIG. 1 a diagrammatic representation of a bifurcated computer-based method 100 for use in providing a final machine learning (ML) inference 102 to a user 104 (via a connected device) using the full pre-fetching method described above, where one of the possible inferences is provided to the user as the final inference in response to an actual input. In FIG. 2 a diagrammatic representation of a second bifurcated computer-based method 200 for use in providing a final inference 102 to a user 104 (via a connected device) using the partial fetching method described above, where possible partial inferences are initially created using a first ML model (e.g., a partial model) and then, based on actual input received, one of those partial inferences is provided to a second ML model to provide a final inference to the user.

Each of the methods disclosed herein are “bifurcated” in that one part of the process is carried out and then, later, a second part of the process is carried out. At a first time period (TIME 1), preferably several possible inferences 110 are pre-generated or pre-calculated based on several possible inputs 114. These possible inferences 110 are generated and are stored to a memory 112 during TIME 1 and any of the possible inference may be provided directly to the user 104 as the final inference (see FIG. 1) or may be used to create the final inference (see FIG. 2), where the final inference provided depends on the actual input that is subsequently received during a second time period (TIME 2). Importantly, in certain implementations of these methods, except in limited cases, the actual input 120 is not used directly to generate the final inference as has historically been done. Instead, the actual input is used to select the best or most acceptable possible inference that was previously generated.

### TIME 1: Inputs, Input Generation, & Storage

The presently described methods 100, 200 each employ a computer-based content generation system (CGS) that may include a first CGS 106A that is configured to receive the possible inputs 114. The first CGS 106A is associated with a trained ML model that is configured to generate possible inferences 110 that are each based on one of the possible inputs 114. In particular, in the case of method 100, ML model 108A is a machine learning model that is configured to provide a full inference in response to each possible input 114. For example, if model 108A is a neural network, it is provided with all layers needed to process the given possible input 114 completely. In the case of method 200, ML model 108B is a machine learning model that is configured to provide a partial inference in response to a given input. For example, if model 108B is a neural network, one or more of the final layers needed to process the given input completely are removed. In either case, the model 108A, 108B may comprise a single ML model or may comprise multiple ML models that function separately or in combination with one another. Preliminarily, in either method 100, 200, a separate second CGS 106B may employ a separate and different second ML model (input generation 108C) to generate and provide possible inputs to CGS 106A. These inputs are preferably generated after CGS 106B is provided with an initial condition. As the term is used herein, an “initial condition” is simply a boundary condition (of any kind) that is used to limit the number and/or type of possible inputs.

In generating possible inputs 114, the input generation model 108C preferably takes into consideration the context of the interaction, including what the user is or is not doing (e.g., visiting a website, calling a customer service phone number, placing an order for food, etc.), information previously provided by the user or that is otherwise made available to the ML model, the date and time of day (e.g., placing an order for food at lunch or at dinner), etc. For example, in predicting a statement a user may say or provide to a chat bot, the input generation model 108C will, ideally, consider the context of the conversation (e.g., visiting a website, login information if available, time of day, etc.) as well as what has been said by the user and the relevant response by the algorithm. While the input generation model 108C may include “hello,” as a greeting, as a possible input at the beginning of each conversation, a proper use of such sequences may exclude this from range of possible inputs later in the conversation because it is not typical to say “hello,” as a greeting, in the middle of an ongoing conversation. This limitation and other similar limitations can avoid the so-called combinatoric explosion (i.e., the rapid explosion of variables or inputs and their possible combinations), or combinatoric explosion of possible inputs that must be generated and considered.

Additionally, model 108C preferably utilizes the past several possible inputs 114 that have been previously generated (i.e., in a sequence of inputs) and/or final inferences 102 (i.e., sequence of outputs) when generating subsequent possible inputs. This is especially important for interactive or back-and-forth interactions, such as a conversation, where inputs are provided to the input generation machine learning model by a user, a response is generated by the machine learning model and provided to the user, and then further inputs are provided by the user (e.g., a conversation with a chat bot), the past several inputs (i.e., the sequence of inputs) should inform the generation process as a further source of input. The input generation model 108C preferably considers what has/has not been said by the user(s) previously as well as any relevant responses previously provided by the model. This is illustrated by the dashed lines connecting final inference 102 and possible inferences 110 to input generation model 108C and CGS 106B. Ingesting this information and having it impact the output of CGS 106C is intended to make that output (i.e., the output possible inputs 114) more relevant. Accounting for past inputs can provide meaningful constraints as well as meaningful predictors and is intended to make that output more relevant.

Next, preferably in either method 100, 200, the possible inputs 114 provided by CGS 106B are communicated and saved to memory 112 along with the possible inferences 110 provided by CGS 106A. Preferably, the possible inputs 114 and possible inferences 110 are each assigned one or more identifiers. These identifiers are saved to the memory in connection with the corresponding possible inputs 114 and/or possible inferences 110 such that they may be used to categorize, sort, and recall the possible inputs and inferences. These identifiers are used to facilitate recalling, filtering, associating, sorting, etc. the possible inputs 114 and possible inferences 110 with each other or with possible inputs or possible inferences or with other relevant characteristics. For example, identifiers might include dates or times, locations, a specific user or group of users, subject matter type, and the like. Once CGS 106A is provided with possible inputs 114, the possible inferences 110 are generated using model 108A or model 10B. Each possible inference 110 is based on a possible input 114 that has been provided to CGS 106A and preferably previously saved to the memory 112. Preferably, once generated by model 108A, 108B, the possible inferences 110 are stored to the memory 112. In preferred implementations, the set of possible inferences 110 is stored in a manner that associates each possible inference with the corresponding possible input 114 upon which it is based. Storage in this manner enables each possible inference to be recalled by the CGS 106A based on the associated possible input 114 more easily. This completes the first half of the bifurcated method.

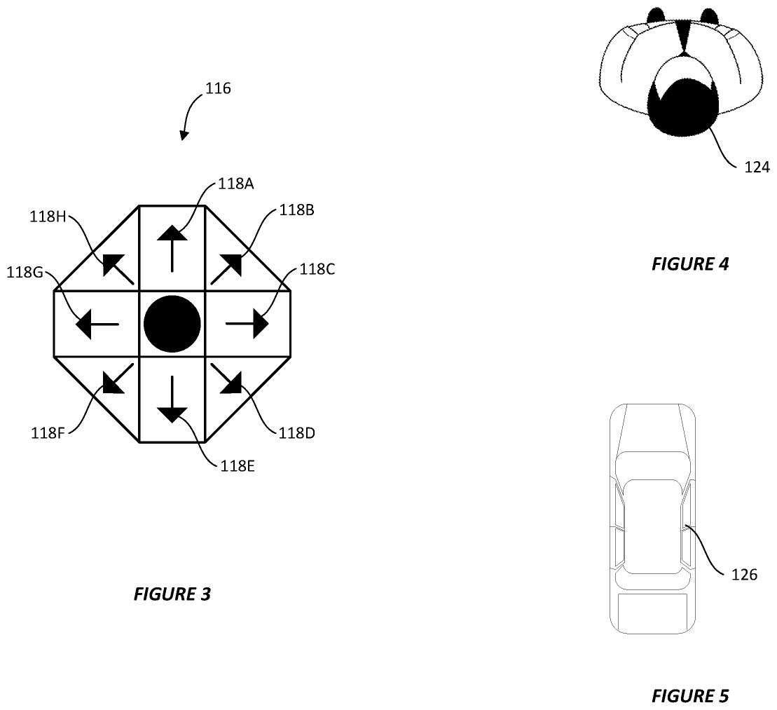

As a simple example, in FIG. 3, a joystick controller 116 for controlling a computer-generated character avatar in a video game is shown. The controller 116 can be tilted in eight different directions, which are indicated by arrows 118A, 118C, 118E, and 118G for each of the four cardinal directions (i.e., north, east, south, west) and arrows 118B, 118D, 118F, and 118H for each of the intermediate directions (i.e., northeast, southeast, southwest, northwest). Accordingly, there are a total of 8 possible inputs that may be provided by a user interacting with the controller 116. With reference to FIG. 4, the resulting inference or response from each of these 8 inputs may be a character avatar 124 taking a single step in the selected direction. By providing these 8 possible inputs to CGS 106A and using model 108A (i.e., in method 100), the resulting potential character movements can be pre-rendered as possible inferences. However, in method 200, the possible inference from model 108A may be used later on in different model 108B to quickly provide inference for a different problem. In this case, movement of the controller 116 might cause a different action to take place. For example, as shown in FIG. 5, a different avatar 126 (i.e., a car) might be controlled using similar actual inputs from the controller 116.

### TIME 2: Acceptability, Matching, & Final Inference Generation

Later, at TIME 2, an actual input 120 is received by CGS 106A in method 100 or, preferably, by a different computer system, CGS 106B, in method 200. The actual input 120 is received from a user 104 of the CGS, another computer system or other input sources. Using the relevant CGS 106, the actual input is compared to the possible inputs 114 that were previously stored to the memory 112 to determine if there is a match between them. In preferred implementations, an “acceptability criterion” is also received by the CGS 106 to assist in the matchmaking process. The “acceptability criterion” is preferably one or more parameters used to determine whether the actual input 120 received acceptably matches one of the previously determined possible inputs 110 and, if so, which of the possible inputs best matches the actual input. Thus, the set of possible inputs 114 is compared against the actual input 120 to identify a matching possible input within the set of possible inputs that acceptably matches the actual input by satisfying the acceptability criterion.

In certain cases, an acceptability criterion is a test used to determine if an actual value or input received by the CGS 106 as an actual input 120 is within an acceptable range of acceptable values or inputs to acceptably match one of the possible inputs 114. In other cases, an acceptability criterion is a characteristic that an actual input 120 must possess or not possess to suitably match a possible input 114. As an example, in the case of the controller 116 (shown in FIG. 3), an acceptability criterion might specify that only a pure “left” tilt (i.e., in direction 118G) having no upward or downward component is matched to a “left” possible input. Likewise, only a pure “right” tilt (i.e., in direction 118C) having no upward or downward component is matched to a “right” possible input. On the other hand, pressing the controller in any of 118H, 118A, or 118B may be matched to the “up” possible input and any of 118F, 118E, or 118D may be matched to the “down” possible input. In other cases, perhaps angled tilts in the intermediate directions are not permitted and only tilts in the cardinal directions are accepted and suitably match a possible input.

In another example, numerical values of 0.6 to 1.4, as actual inputs, may be matched to a possible input of “1,” whereas numerical values of 1.5 to 2.4, as actual inputs, may be matched to a possible input of “2.” Accordingly, these types of acceptability criteria allow for users to interact with the CGS 106 with selectable degrees of precision.

In yet another example, possible inputs might include the words “cup” and “spoon.” Each of those possible inputs may be provided with different sets of possible inferences. Additionally, each of those terms may be suitably interchangeable with a range of other terms. For example, the terms “glass,” “chalice,” “goblet,” etc. may be provided to the CGS 106A as part of a suitability criterion, such as in a lookup table, as suitable matches to the word “cup.” In that case, if one of these other words are provided by a user, CGS 106 would accept any of those terms as suitably matching the possible input “cup.” However, since the words “plate” and “bowl” are not included in the lookup table, they would not suitably match the possible input “cup” or “spoon.” At the same time, other words such as “ladle” or “dipper” may suitably match “spoon.” In certain scenarios, this type of acceptability criterion that accepts or rejects certain actual inputs based on the possible inputs may be extremely important. For example, relevant to first responders, the word “weapon” may be suitably interchangeable with a range of other terms, such as “gun,” “knife,” “bomb,” “bat,” etc. If a police trainee states “drop the gun” in a training scenario that utilizes the methods described herein, CGS 106 may be designed to accept that term as suitably matching “weapon.” On the other hand, “drop the spoon” likely should not be accepted as suitably matching “weapon.”

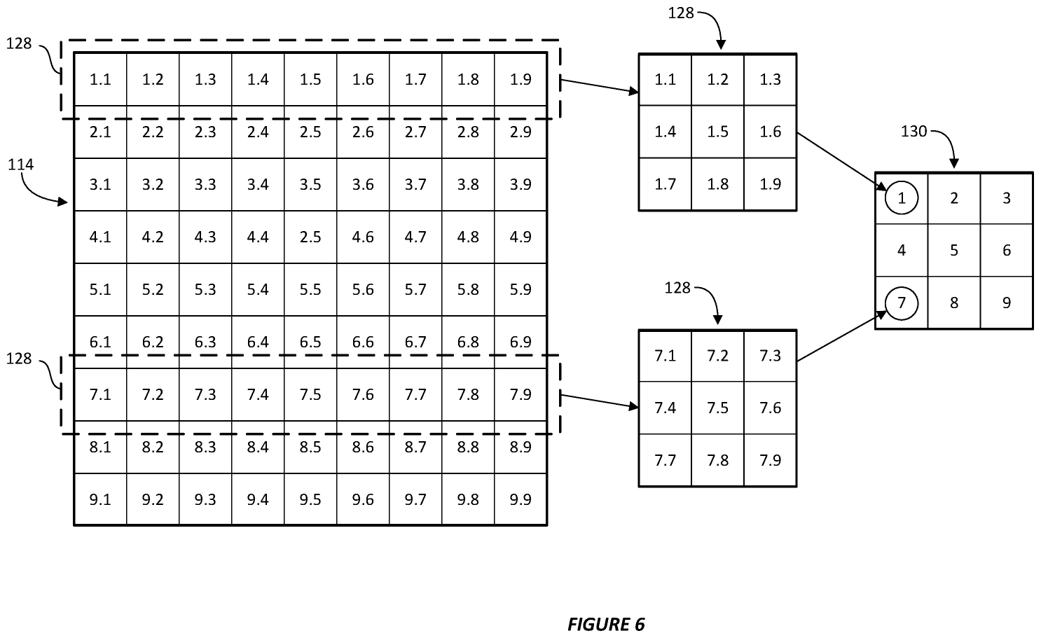

Thus, as the examples above illustrate, in certain implementations, certain substitution inputs may be associated with and configured to be substituted in place of a substitution sub-set of the possible inputs (e.g., substituting “weapon,” a substitution input, in place of any of possible inputs “gun,” “knife,” “bomb,” “bat,” etc.). This concept is illustrated in FIG. 6, where a table of possible inputs 114 comprised of the numbers 1.1 through 9.9 and excluding all integers is provided. A pair of substitution sub-sets 128 of these possible are shown and have been placed into separate and smaller tables, including a first sub-set comprised of numbers 1.1 through 1.9 and a second sub-set comprised of numbers 7.1 through 7.9. Suppose the acceptability criteria in this case specifies that if numbers 1.1 through 1.9 are received as actual inputs, they all acceptably match and are substituted for (i.e., replaced by) the possible input “1” (i.e., a substitution input 130). Likewise, the acceptability criteria may also specify that if numbers 7.1 through 7.9 are received as actual inputs, they acceptably match and are substituted for possible input “7.” Thus, if any of numbers 1.1 through 1.9 are provided as actual inputs, the number “1” would be substituted in its place, and the possible inference for number “1” would be output to the user. Similarly, if any of numbers 7.1 through 7.9 are provided as actual inputs, the number “7” would be substituted in its place, and the possible inference for number “7” would be output to the user. In other implementations, a possible input acceptably matches the actual input only if the possible input and actual input are identical. For example, 1.0, as an actual input, may be matched to “1,” but 1.1, as an actual input, might not be matched to “1.”

In certain implementations, the acceptability criterion may be in the form of a lookup table or collection of acceptable values or inputs (collectively, a “lookup table”), where any actual input that is found within that lookup table is acceptable and is substituted for a given value assigned to the lookup table. In other cases, the acceptability criterion is a maximum distance value provided to the CGS. In such cases, a vector embedding may be used to convert the actual and possible input data into numbers so that they may be numerically compared to one another. In that case, the acceptability criterion may specify that the distance separating the actual and possible input must be greater than or less than a given numerical distance (e.g., less than 3.0 units) for the possible input and the actual input to “acceptably match” one another.

In certain implementations, each of the possible inputs 114 of the set of possible inputs is associated with only one substitution value and none of the possible inputs of the set of possible inputs is associated with more than one substitution input. This, therefore, would prevent a scenario where an actual input is potentially replaced by more than one substitution input.

If, following the above-described process, a matching possible input 114 is identified in the set of possible inputs that is stored to the memory 112, CGS 106 may then be used to substitute the matching possible input in place of the actual input to recall the corresponding possible inference. In certain implementations, such as in method 100, the recalled possible inference 110 is then output as the final inference 102 to the user 104 in response to receiving the actual input 120 without any further processing. This is the full “pre-fetching” method described above. However, in the case of “partial fetching,” shown in FIG. 2, the recalled possible inference 110 is preferably provided to a different and complete ML model 108D that is provided with all layers needed to provide a full inference based on the recalled possible inference. The output of ML model 108D (i.e., a second possible inference) is then provided to the user 104 as the final inference 102. Preferably, in providing the final inference 102 to the user 104, where a matching possible input is identified, inference is never performed on the actual input. Instead, inference is only ever performed on the possible inputs 114 or possible inferences 110. Additionally, in general, the set of possible inferences is preferably generated prior to receipt of the actual input and not in real time with the receipt of the actual input.

However, in certain cases, where a suitable match between the actual input 120 and the possible inputs 114 is not identified in the set of possible inputs stored to the memory 1112, an “on-the-fly” (i.e., as needed, when needed, or on-demand) inference may be performed on the actual input by any of the ML models discussed above 108A, 108B, 108D at TIME 1 or at TIME 2. The result of the on-the-fly inference may also be delivered from model 108A to the user 104 as the final inference, may be delivered from model 108B to CGS 106C and model 108D as the first inference (i.e., or as an input to a different model), or may be delivered from model 108D to the user as the final (i.e., second) inference.

As noted previously, the possible inference and final inference are each preferably output to a memory and stored, such as a memory associated with a business logic system or other computer system for use or possible use by that system or by a user of that system. For example, in certain cases, eventually, the inference may be output to a connected device (e.g., a PC, mobile device, headset, etc.). In certain cases, the inference may be output directly, including possibly without being stored to a memory first. The particular device that receives the inference will vary depending on the application for which it is used.

Preferably, in providing final inferences using the pre-fetching and partial fetching methods described above is much faster than providing similar inferences using conventional methods. It is believed that, in at least certain cases, providing an inference directly using the ML models described above without using the possible inferences (i.e., an “on-the-fly” method) would exceed a response time requirement of the corresponding CGS for providing said final inference in response to the CGS receiving the actual input, but providing the same final inference indirectly by substituting the matching possible input in place of the actual input and then recalling and outputting from the CGS the possible inference that is associated with the matching possible input as said final inference would not exceed the response time requirement. In certain of these cases, the response time requirement is a system-required response time of the CGS. However, in other cases, the response time requirement is a user-specified response time requirement. In certain of those cases, the user-specified response time requirement provides a different amount of time than a system-required response time of the CGS. For example, the user-specified response time requirement may provide more or less time than the system-required response time.

Although this description contains many specifics, these should not be construed as limiting the scope of the invention but as merely providing illustrations of some of the presently preferred implementations thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A method for providing a machine learning (ML) final inference to a user comprising:
providing a source of possible inputs for a ML model;
providing a computer-based content generation system (CGS) that is configured to receive possible inputs from the source of possible inputs, the CGS comprising:
a trained ML model that is configured to provide possible inferences that are each based on one of said possible inputs;
a memory;
with the CGS, receiving a set of said possible inputs from said source of inputs and storing the set of possible inputs to the memory;
generating a set of said possible inferences using the ML model, wherein each possible inference in the set of possible inferences is based on a possible input of the set of possible inputs;
storing the set of possible inferences to the memory in a manner that associates each possible inference with the possible input upon which it is based such that the possible inference may be recalled by the CGS based on the associated one possible input;
receiving an actual input and an acceptability criterion with the CGS;
comparing the set of possible inputs stored to the memory with the actual input using the CGS to identify a matching possible input within the set of possible inputs that acceptably matches the actual input by satisfying the acceptability criterion;
if a matching possible input is identified in the set of possible inputs stored to the memory, using the CGS to substitute the matching possible input in place of the actual input by recalling and then outputting the possible inference that is associated with the matching possible input as said final inference to the user via a connected device in response to receiving the actual input,
wherein, in providing the final inference to the user where a matching possible input is identified, inference is never performed on the actual input and the set of said possible inferences is generated prior to receipt of the actual input and not in real time with the receipt of the actual input.

2. The method of claim 1 wherein, if a matching possible input is not identified in the set of possible inputs stored to the memory, performing an on-the-fly inference on the actual input and delivering a result of the on-the-fly inference to the user as said final inference.

3. The method of claim 2 further comprising updating the ML model based on the actual input as well as the final inference that was generated on-the-fly using the ML model in response to the actual input.

4. The method of claim 1 wherein the source of possible inputs comprises an input generation model that is different from the ML model and that is configured to generate said set of possible inputs based on an initial condition, the method comprising: receiving said initial condition and generating the set of said possible inputs using the input generation model based on the initial condition.

5. The method of claim 4 wherein the CGS comprises a first computer system and a second and different computer system, and wherein the input generation model is used by the first computer system to provide at least a portion of the set of possible inputs and the second computer system is used to generate the possible inferences or to generate and provide the final inference to the user.

6. The method of claim 1 wherein providing the final inference directly using the ML model and the actual input and without using the possible inferences would exceed a response time requirement of the CGS for providing said final inference in response to the CGS receiving the actual input but providing the final inference indirectly by substituting the matching possible input in place of the actual input and then recalling and outputting from the CGS the possible inference that is associated with the matching possible input as said final inference would not exceed the response time requirement.

7. The method of claim 6 wherein the response time requirement is a system-required response time of the CGS.

8. The method of claim 6 wherein the response time requirement is a user-specified response time requirement.

9. The method of claim 8 wherein the user-specified response time requirement provides a different amount of time than a system-required response time of the CGS.

10. The method of claim 1 further comprising providing a sequence of final inferences to the user, each based on an actual input in a sequence of actual inputs received from the user.

11. The method of claim 1 further comprising assigning one or more identifiers to each of the set of possible inputs and, when storing the set of possible inputs and set of possible inferences to the memory, categorizing each of the set of possible inputs according to at least one of the one or more identifiers.

12. The method of claim 1 further comprising:
providing a plurality of substitution inputs that are each associated with and configured to be substituted in place of a substitution sub-set of the set of possible inputs;
generating said set of said possible inferences using the ML model, wherein each possible inference in the set of possible inferences is based on a substitution input of the plurality of substitution inputs;
if a matching possible input is identified, using the CGS to substitute the substitution input that is associated with the substitution sub-set that contains the matching possible input in place of the matching possible input by recalling and then providing the possible inference that is associated with the matching possible input as said final inference to the user in response to receiving the actual input.

13. The method of claim 12 wherein each of the possible inputs of the set of possible inputs is associated with only one substitution value and none of the possible inputs of the set of possible inputs is associated with more than one substitution input.

14. The method of claim 1 wherein one of the possible input acceptably matches the actual input only if the possible input and actual input are identical.

15. The method of claim 1 wherein the acceptability criterion is a maximum distance value provided to the CGS, the method further comprising:
creating a vector embedding for the actual input and possible inputs and then numerically comparing the vector embeddings when identifying a matching possible input, wherein a possible input acceptably matches the actual input if the possible input and actual input are separated by a numerical distance that does not exceed the maximum distance.

16. A method for providing a machine learning (ML) final inference to a user comprising:
providing a source of possible inputs for a ML model;
providing a computer-based content generation system (CGS) that is configured to receive possible inputs from the source of possible inputs, the CGS comprising:
a trained first ML model that is configured to provide first possible inferences that are each partial inferences based on one of said possible inputs;
a trained second ML model that is configured to provide second possible inferences that are each partial inferences based on one of the first possible inferences;
a memory;
with the CGS, receiving a set of said possible inputs from said source of inputs and storing the set of possible inputs to the memory;
generating a set of said first possible inferences using the first ML model, wherein each first possible inference is based on a possible input of the set of possible inputs;
storing the set of possible inferences to the memory in a manner that associates each possible inference with the possible input upon which it is based such that the possible inference may be recalled by the CGS based on the associated possible input;
receiving an actual input and an acceptability criterion with the CGS;
comparing the set of possible inputs stored to the memory with the actual input using the CGS to identify a matching possible input within the set of possible inputs that acceptably matches the actual input by satisfying the acceptability criterion; and
if a matching possible input is identified in the set of possible inputs stored to the memory, using the CGS to substitute the matching possible input in place of the actual input by recalling and then providing the first possible inference that is associated with the matching possible input as an input to the second ML model;
generating said second possible inference using the second ML model based on the first possible inference that is associated with the matching possible input and that is provided as said input to the second ML model; and
outputting the second possible inference to the user via a connected device as said final inference,
wherein, in providing the final inference to the user where a matching possible input is identified, inference is never performed on the actual input and the set of said first possible inferences is generated prior to receipt of the actual input and not in real time with the receipt of the actual input.

17. The method of claim 16 wherein the source of possible inputs comprises an input generation model that is different from the first ML model and the second ML model and that is configured to generate said set of possible inputs based on an initial condition, the method comprising: receiving said initial condition with the CGS; generating the set of said possible inputs using the input generation model based on the initial condition.

18. The method of claim 17 wherein the CGS comprises a first computer system and a second and different computer system, and wherein the input generation model is used by the first computer system to provide at least a portion of the set of possible inputs and the second computer system is used to generate the possible inferences or to generate and provide the final inference to the user.

19. The method of claim 16 wherein, if a matching possible input is not identified in the set of possible inputs stored to the memory, performing an on-the-fly inference on the actual input and delivering a result of the on-the-fly inference as the input to the second ML model.

20. The method of claim 19 further comprising updating at least one of the first ML model or the second ML model based on the actual input as well as the final inference that was generated on-the-fly using the ML model in response to the actual input.

21. The method of claim 16 further comprising providing a series of final inferences to the user and updating the input generation model based on at least one of a prior actual input used or a prior final inference previously provided by the CGS in the series of final inferences.

22. The method of claim 16 further comprising:
providing a plurality of substitution inputs that are each associated with and configured to be substituted in place of a substitution sub-set of the possible inputs of the set of possible inputs;
generating said first possible inferences using the second ML model, wherein each first possible inference is based on a substitution input;
if a matching possible input is identified, substituting the substitution input that is associated with the substitution sub-set that contains the matching possible input in place of the matching possible input by recalling and then providing the first possible inference that is associated with the substitution input as the input to the second ML model;
generating said second possible inference using the second ML model based on the substitution input.

23. The method of claim 22 wherein each of the possible inputs of the set of possible inputs is associated with only one substitution value and none of the possible inputs of the set of possible inputs is associated with more than one substitution input.

24. The method of claim 16 wherein a possible input acceptably matches the actual input only if the possible input and actual input are identical.

25. The method of claim 16 wherein the acceptability criterion is a maximum distance value provided to the CGS, the method further comprising:
creating a vector embedding for the actual input and possible inputs and then numerically comparing the vector embeddings when identifying a matching possible input, wherein a possible input acceptably matches the actual input if the possible input and actual input are separated by a numerical distance that does not exceed the maximum distance.
